(19) United States
(12) Patent Application Publication
(10) Pub. No.: US 2021/0179450 A1
(43) Pub. Date: Jun. 17, 2021

(54) MEMBRANE FOR WATER PURIFICATION

(71) Applicant: King Abdullah University of Science and Technology, Thuwal (SA)

(72) Inventors: Suzana Pereira NUNES, Thuwal (SA); Husnul MAAB, Thuwal (SA); Lijo FRANCIS, Thuwal (SA)

(21) Appl. No.: 17/189,086

(22) Filed: Mar. 1, 2021

Related U.S. Application Data
(63) Continuation of application No. 13/765,228, filed on Feb. 12, 2013, now abandoned.
(60) Provisional application No. 61/717,928, filed on Oct. 24, 2012.
(60) Provisional application No. 61/598,334, filed on Feb. 13, 2012.

(51) Int. Cl. C02F 1/44; B01D 67/00; B01D 71/62; B01D 69/14

(52) U.S. Cl. CPC C02F 1/44; B01D 67/0016; B01D 67/0006; B01D 71/52; B01D 69/148; B01D 67/0079; B01D 71/62

(57) ABSTRACT

Fluorinated polyazoles, porous membranes made therefrom, methods of making the porous membrane, and methods of using the porous membrane for purifying water, are described. For example, the present disclosure describes fluorinated polyoxadiazoles and polytriazoles that are capable of fabricating flat sheet, hollow fiber, and electrospun porous membranes are described.

### CLAIM FOR PRIORITY

This application is a continuation of U.S. patent application Ser. No. 13/765,228, filed Feb. 13, 2013, which claims priority to U.S. Patent Application No. 61/598,334, filed Feb. 13, 2012, and U.S. Patent Application 61/717,928, filed Oct. 24, 2012, each of which is hereby incorporated by reference in its entirety.

### TECHNICAL FIELD

This invention relates to a membrane for water purification.

### BACKGROUND OF THE INVENTION

Water can be purified by passing through membranes using a variety of methods.

### SUMMARY

In one aspect, a membrane for fluid purification includes a polyazole polymer. The polyazole polymer can include a polyoxadiazole or polytriazole, or a copolymer thereof.

In certain embodiments, the polymer can include repeating units:

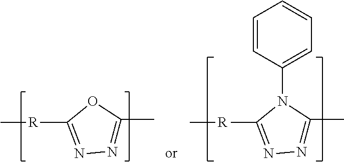

or their copolymers, where R is,

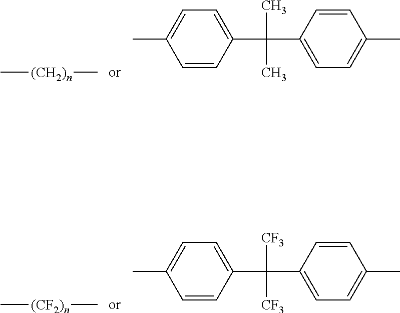

in which n is an integer from 1-8.

The membrane can be a flat sheet, hollow fiber or electrospun.

The membrane can be used in a system for purifying water. For example, a method of purifying water can include passing water through the membrane.

A method of forming the membrane can include dissolving the polymer in an organic solvent and casting the membrane, where the method of casting the membrane includes phase inversion or electrospinning.

Other aspects, embodiments, and features will be apparent from the following description, the drawings, and the claims.

### DETAILED DESCRIPTION OF THE DRAWINGS

FIG. 1 is a micrograph depicting a hydrophobic porous membrane prepared by phase inversion from fluorinated polyoxadiazole.

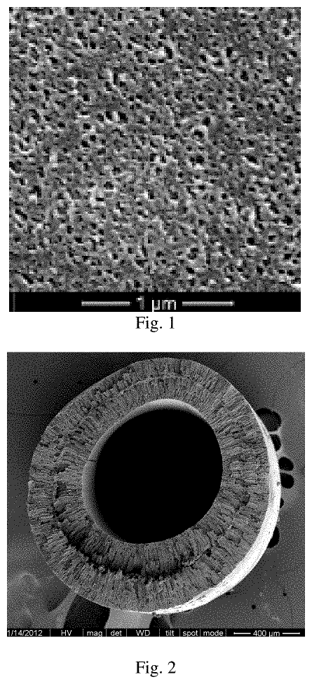

FIG. 2 is a micrograph depicting a hydrophobic porous membrane prepared by phase inversion in a hollow fiber machine from fluorinated polyoxadiazole.

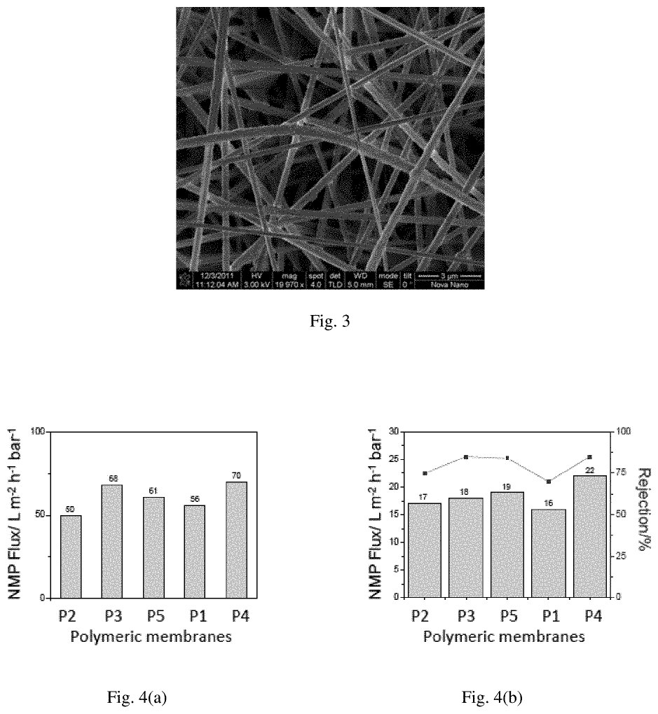

FIG. 3 is a micrograph depicting a hydrophobic porous membrane prepared by electrospinning from fluorinated polyoxadiazole.

FIG. 4(a) depicts the flux of brilliant blue in N-methylpyrrolydone through five polyazole membranes, each with a different R group.

FIG. 4(b) depicts the rejection of brilliant blue in N-methylpyrrolydone through five polyazole membranes, each with a different R group.

### DETAILED DESCRIPTION OF THE INVENTION

Polymers have been prepared including polyazole monomeric units, which can be used to form a porous membrane for membrane distillation. In particular, the polymers are based on polyazole polymers having hydrophobic groups. Exemplary polymers include compositions including the repeating units:

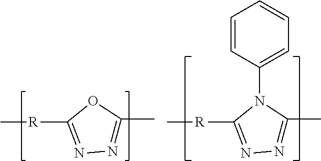

or their copolymers, where R is, for example,

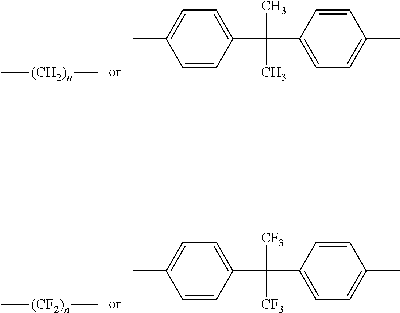

in which n is an integer from 1-8. R could also be another hydrophobic group. For example, a copolymer can be prepared with R being

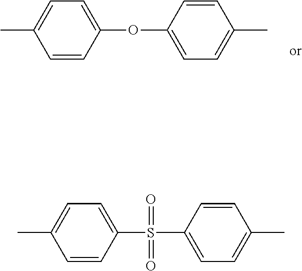

Membranes prepared from the above molecules can be stable at temperatures higher than 200° C. The hydrophobic segments enhance the suitability of the membrane for membrane distillation.

The polymers are prepared following a known procedure for dense membranes for fuel cell application. (See, for example, D. Gomes, S. P. Nunes, Fluorinated polyoxadiazole for high-temperature polymer electrolyte membrane fuel cell, J. Membrane Sci. 321 (1) (2008) 114-122; M. Ponce, D. F. Gomes, S. Nunes, V. Abetz, Manufacture of a functionalized polytriazole polymer, US20080182964 A1 (2008); D. F. Gomes, J. Roeder Jesus, S. Nunes, Method for production of a sulfonated poly(l,3,4-oxadiazole) polymer, US20080318109 A1 (2008); M. L. Ponce, J. Roeder, D. Gomes and S. P. Nunes, Stability and Proton Conductivity of Sulfonated Polytriazole and Polyoxadiazole Membranes, Asia Pacific J. Chemical Engineering, 5 (1) (2010) 235-241, each of which is incorporated by reference in its entirety.) Other polyoxadiazoles have been reported by other authors (See D. F. Gomes, M. R. Loos, Method for the Synthesis of a Polyoxadiazole Polymer, U.S. Pat. No. 7,847,054 (2010); M. R. Loos, V. Abetz, K. Schulte, Polyoxadiazole Polymers, EP2241585 (A1) (2010), each of which is incorporated by reference in its entirety). The polymers can be blended, for example, with a polysulfone, a polyetherimide, one or more fluorinated additives, or have modified surfaces.

The polymers with the composition shown above are dissolved in a suitable solvent, for example, an organic solvent (e.g., dimethylformamide, dimethylacetamide, or dimethylsulfoxide), to form a casting solution. The casting solution is used for manufacture of porous membranes by phase inversion, consisting of casting the polymer in the form of a flat sheet (as shown in FIG. 1), a hollow fiber (as shown in FIG. 2) and immersion in water or by electrospinning (as shown in FIG. 3). Porous membranes have been prepared by phase separation from polyvinylfluoride, which is not as hydrophobic as the polymers described herein.

The polymer membranes can be used in membrane distillation, which is an emerging technology for water desalination and reuse with low energy consumption. A review of this technology has been recently published, which reviews various membranes for membrane distillation, but does not include any based on polyazole. (See M. Khayet, Adv. Colloid Int. Sci., 164 (2011) 56, which is incorporated by reference in its entirety.) In particular, the membranes can be used for desalination or water reuse. In some circumstances, the water purification can include brine desalination. In particular, the polyazole polymer can be a polyoxadiazole or polytriazole, or a copolymer thereof.

Advantages of the developed polymer membranes include the high thermal stability of the membranes, high hydrophobicity, and high porosity. For example, the polymer membranes can be stable at temperatures up to 300° C. The high hydrophobicity membranes can have a high water-surface contact angle.

Other membranes for membrane distillation have been reported based on polypropylene or semicrystalline polytetrafluorethylene. (See M. Khayet, Adv. Colloid Int. Sci., 164 (2011) 56, which is incorporated by reference.) These membranes have been prepared by other methods (e.g., extrusion). They are hydrophobic but do not have the high porosity achieved here. Both polypropylene and semicrystalline polytetrafluorethylene can be difficult to dissolve and generally cannot be manufactured into membranes at room temperature as the membranes described here can be. The polymers described here are much more soluble, rendering them suitable for membrane manufacture at room temperature in commercial machines, conventionally used for polysulfone and other polymers traditionally used for ultrafiltration, and other uses.

A membrane with stability in organic solvents can be achieved by the two processes described below.

In one process, polyazoles with very low solubility in regular organic solvents can be obtained by choosing the appropriate R group, examples of which include:

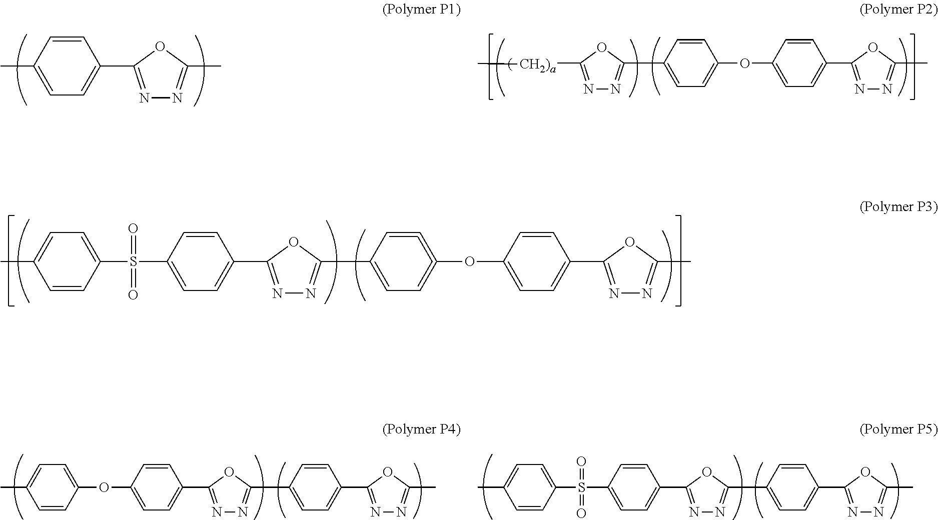

However, these polymers are soluble in strong acids such as sulfuric acid.

The procedure by which these membranes are manufactured can be conducted by phase inversion with polymer solubilization in acid, casting and immersion in water. By this process, asymmetric porous membranes are obtained, which are hardly soluble in common organic solvents. Water flux as high as 300 L/m² h bar have been confirmed. Flux and rejection of brilliant blue in N-methyl pyrrolidone are shown in FIGS. 4(a) and (b).

In another process, an asymmetric porous membrane prepared by phase inversion can be prepared by functionalizing the polytriazole by incorporating R1 anchoring groups for further crosslinking reactions. An example of this is

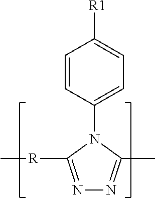

where R1 can be OH, SO₃H, or another reactive group. In this process, the membrane can then be immersed in a solution containing bifunctional molecules which act as crosslinkers, which react with R1 at different temperatures.

An example of a reaction is

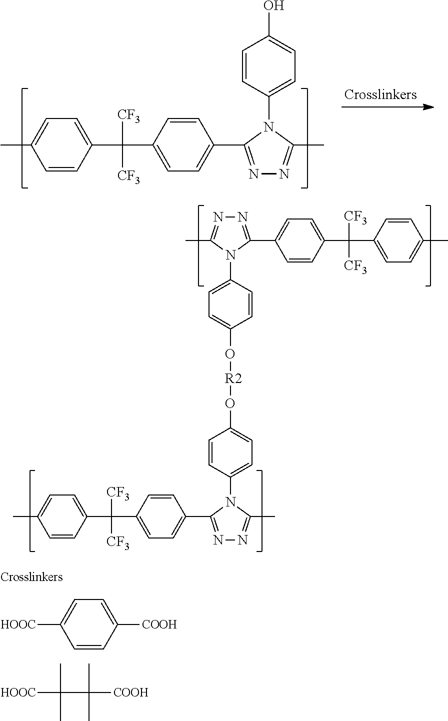

Where R2 can be, for example, —(CH₂)ₙ— (n is 1, 2, 3, 4, 5, 6, 7 or 8) or aryl segments or polyether segments. After functionalization with SO₃H as R1, diamines can be used as crosslinkers.

The polymer or membrane can also be reacted, by hydrolysis in the presence of acids, with dipodal silanes to form bridges between the polymer chains. Examples of dipodal silanes include

(C₂H₅O)₃Si—(CH₂)₈—Si(C₂H₅O)₃,

(C₂H₅O)₃Si-Aryl-Si(C₂H₅O)₃, and

(CH₃O)₃Si—(CH₂)₃—NH—(CH₂)₃—Si(CH₃O)₃.

The polymer or membrane can also be reacted with monofunctionalized silanes instead of dipodal silanes. For example, 3-Glycidoxypropyltrimethoxysilane can be used in the reaction, followed by a reaction with diamine for crosslinking.

The membranes prepared by the two processes above can be applied to water purification containing organic solvents, as well as for purification of solutions prepared in organic solvents (organophilic ultrafiltration). The membranes can also be used as porous support for preparation of composite membranes (e.g., thin-film composite), by coating with organic solutions by a process comprising steps of washing with organic solvents. The membranes can also be used in membrane reactors, requiring operation in the presence of organic solvents and at temperatures as high as 200° C. or even higher.

Membranes have been developed that are suitable for water purification. In particular, hydrophobic membranes have been developed that are suitable for membrane distillation. Membranes have been manufactured and tested for membrane distillation.

Other embodiments are within the scope of the following claims.

What is claimed is:

1. A hydrophobic porous membrane comprising a fluorinated polyazole polymer.

2. The membrane of claim 1, wherein the fluorinated polyazole polymer is a fluorinated polyoxadiazole, a fluorinated polytriazole, or a copolymer thereof.

3. The membrane of claim 1, wherein the fluorinated polyazole polymer includes at least one repeating unit selected from the group consisting of: 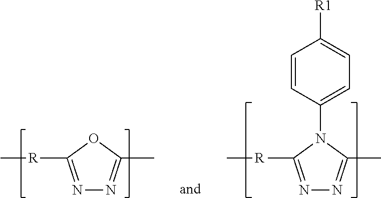
wherein R is —(CF₂)ₙ— or 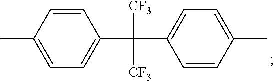
R₁ is H; and n is an integer from 1-8.

4. The membrane of claim 3, wherein the fluorinated polyazole polymer further comprises at least one repeating unit selected from the group consisting of: 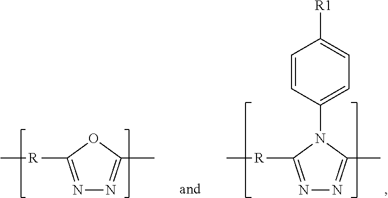
wherein R is —(CH₂)ₙ— or 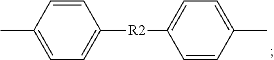
R1 is H, OH, SO₃H, (CH₂)ₙH, triazole, imidazole, tetrazole, CN, CH₂Cl, CH₂Br, CH₂I or SH;
R2 is O, SO₂, or C(CH₃)₂; and
n is an integer from 1-8.

5. The membrane of claim 4, wherein the fluorinated polyazole polymer is poly(diphenyl hexafluoroisopropylidene oxadiazole), poly(diphenyl hexafluoroisopropylidene triazole), or poly (diphenyl hexafluoroisopropylidene oxadiazole-co-diphenylether oxadiazole).

6. The membrane of claim 1, wherein the membrane is a flat sheet membrane, a hollow fiber membrane or an electrospun membrane.

7. A method of forming a hydrophobic porous membrane comprising a fluorinated polyazole polymer, comprising:
dissolving the fluorinated polyazole polymer in an organic solvent to form a solution and
electrospinning the solution or subjecting the solution to phase inversion.

8. The method of claim 7, wherein the fluorinated polyazole polymer is a fluorinated polyoxadiazole, a fluorinated polytriazole, or a copolymer thereof.

9. The method of claim 7, wherein the fluorinated polyazole polymer includes at least one repeating unit selected from the group consisting of: 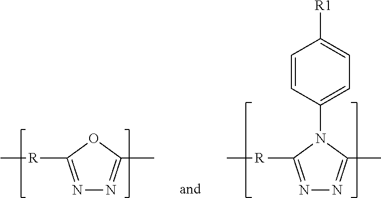
wherein R is —(CF₂)ₙ— or 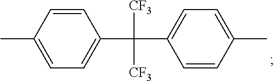
R₁ is H; and n is an integer from 1-8.

10. The method of claim 9, wherein the fluorinated polyazole polymer further comprises at least one repeating unit selected from the group consisting of: 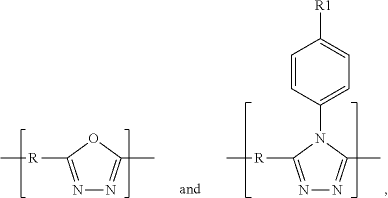
wherein R is —(CH₂)ₙ— or 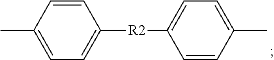
R1 is H, OH, SO₃H, (CH₂)ₙH, triazole, imidazole, tetrazole, CN, CH₂Cl, CH₂Br, CH₂I or SH;
R2 is O, SO₂, or C(CH₃)₂; and
n is an integer from 1-8.

11. The membrane of claim 10, wherein the fluorinated polyazole polymer is poly(diphenyl hexafluoroisopropylidene oxadiazole), poly(diphenyl hexafluoroisopropylidene triazole), or poly (diphenyl hexafluoroisopropylidene oxadiazole-co-diphenylether oxadiazole).

12. The method of claim 7, wherein the organic solvent is N-methyl pyrrolidone, dimethylformamide, dimethylacetamide, or dimethylsulfoxide.

13. The method of claim 7, wherein the solution is subjected to phase inversion, and phase inversion comprises casting the solution into a flat sheet and immersing the flat sheet in water.

14. The method of claim 7, wherein the solution is subjected to phase inversion, wherein phase inversion comprises casting the solution in a hollow fiber machine and forming a hollow fiber membrane, optionally wherein the hollow fiber membrane is asymmetric.

15. A method of desalinating water comprising separating purified water from brine via membrane distillation using a hydrophobic porous membrane comprising a fluorinated polyazole polymer.

16. The method of claim 15, wherein the fluorinated polyazole polymer is a fluorinated polyoxadiazole, a fluorinated polytriazole, or a copolymer thereof.

17. The method of claim 15, wherein the fluorinated polyazole polymer includes at least one repeating unit selected from the group consisting of: 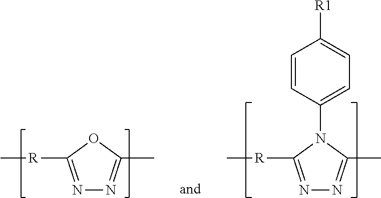
wherein R is —(CF₂)ₙ— or 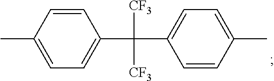
R₁ is H; and n is an integer from 1-8.

18. The method of claim 17, wherein the fluorinated polyazole polymer further comprises at least one repeating unit selected from the group consisting of: 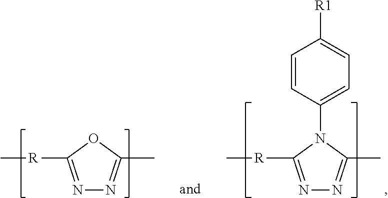
wherein R is —(CH₂)ₙ— or 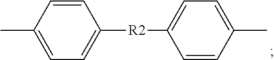
R1 is H, OH, SO₃H, (CH₂)ₙH, triazole, imidazole, tetrazole, CN, CH₂Cl, CH₂Br, CH₂I or SH;
R2 is O, SO₂, or C(CH₃)₂; and
n is an integer from 1-8.

19. The method of claim 18, wherein the fluorinated polyazole polymer is poly(diphenyl hexafluoroisopropylidene oxadiazole), poly(diphenyl hexafluoroisopropylidene triazole), or poly (diphenyl hexafluoroisopropylidene oxadiazole-co-diphenylether oxadiazole).

20. The method of claim 15, wherein the membrane is a flat sheet membrane, a hollow fiber membrane or an electrospun membrane.
